(19) United States
(12) Patent Application Publication
(10) Pub. No.: US 2024/0035529 A1
(43) Pub. Date: Feb. 1, 2024

(54) SAFETY BRAKE SYSTEM FOR ROBOT ARM JOINTS

(71) Applicant: Eindhoven Medical Robotics B.V., Eindhoven (NL)

(72) Inventor: Marc Janssens, EINDHOVEN (NL)

(21) Appl. No.: 18/266,114

(22) PCT Filed: Dec. 6, 2021
(86) PCT No.: PCT/NL2021/050739

§ 371 Date: Jun. 8, 2023

(30) Foreign Application Priority Data
Dec. 9, 2020 (NL) 2027077

(51) Int. Cl. F16D 49/10; B25J 9/00; F16D 59/00; F16D 65/16

(52) U.S. Cl. CPC F16D 49/10; B25J 9/0009; F16D 59/00; F16D 65/16; F16D 2121/30

(57) ABSTRACT

The invention relates to a safety brake system comprising a round rotatable shaft locked with a constant-on braking device activated by a spring and a switch-off device for the braking device that counteracts the spring, so that the shaft is unlocked and can rotate when the switch-off device is active. According to the invention the constant-on brake device comprises a brake shoe pushed against the shaft by the spring and the switch-off device is a piezo actuator that counteracts the spring. The brake system is normally constant on since the spring pushes the brake shoe against the shaft. When the shaft needs to rotate the piezo actuator counteracts the spring, thus releasing the brake shoe from the shaft. In case of an emergency or when the shaft needs to be locked, the power to the piezo activator is shut off and the spring pushes the brake shoe against the shaft to stop any rotation.

In many applications safety brakes are required for rotating shafts. These safety brakes are not used for normal braking but are only operated in an emergency situation or they are used as a parking brake. These types of brakes are especially useful in the joints of robot arms. Such arms often contain many joints that need to be locked in case of an emergency or when one degree of freedom of the robot arm is not used.

The invention relates to a safety brake system comprising a round rotatable shaft locked with a constant-on braking device activated by a spring and a switch-off device for the braking device that can counteract the spring, so that the shaft can be unlocked and can rotate when the switch-off device is active.

Such a safety brake system is known from US 20140246279A1 where a safety brake is described. The known brake system has balls in recesses of a ball carrier rotor rigidly attached to the shaft. The balls are squeezed between rotationally fixed but axially movable spring-loaded surfaces, thus locking the balls. The locked balls lock the shaft via the recesses and the carrier rotor. The switch-off device is a solenoid that counteracts the spring thus moving the surfaces axially away from the balls, and freeing the balls so that the shaft can rotate.

The known safety brake system is complex, rather large and heavy. Moreover the solenoid uses a lot of energy and thus generates heat and the balls have point contacts on the surfaces and thus cause rapid wear.

The aim of the invention is to provide a safety brake system that is compact, light, energy friendly and causes less wear.

According to the invention the constant-on braking device comprises a brake shoe that can be pushed against the shaft by the spring and the switch-off device is a piezo actuator that can counteract the spring. The brake system is normally constant on since the spring pushes the brake shoe against the shaft. When the shaft needs to rotate the piezo actuator counteracts the spring, thus releasing the brake shoe from the shaft. In case of an emergency or when the shaft needs to be locked, the power to the piezo activator is shut off and the spring pushes the brake shoe against the shaft to stop any rotation. The inventive brake system is significantly more compact compared to known solutions, as no ball carrier rotor or brake disc is required.

As a consequence, performance of the overall system can improve and design constraints relaxed. A piezo actuator is very quick it switches in much less than 1 ms. Thus the switch-off device works also very fast. Moreover a piezo actuator consumes little energy and thus has a low heat dissipation. In case of a power failure the piezo actuator will receive no power, so that it cannot counteract the spring anymore. The spring will then push the brake shoe against the shaft. Thus providing a fail safe locking mechanism for the shaft, i.e. the shaft will be locked in case of a power failure.

The use of piezo actuators for brakes is known from for instance US 2013341132A1. But in these cases the piezo actuator is used to activate the brake and not for de-activating the brake. Thus the piezo actuator needs to be activated for the brake to work. This is completely contrary to the use of the piezo activator in the present invention.

The brake shoe fits to the outer radius of the shaft. The dimensions of the brake shoe, i.e. the axial (width) and the tangential (length along the radius of the shaft) dimensions depend on the required braking force. The brake shoe has a larger contact surface with the shaft than the balls of the known device, thus the inventive system is less likely to wear.

Preferably the shaft is surrounded by a brake body comprising a cylindrical hole with a sliding fit to the shaft, the brake body is fixed to a stationary non-rotating element, where the brake body is provided with a fully open radial slit that splits the brake body and a partially open radial slit that provides an elastic region in the brake body, where the brake shoe comprises the part of the brake body between the fully open radial slit and the partially open radial slit and where the brake shoe can pivot around the elastic region and can be loaded by the spring against the shaft.

The brake body comprises a circular hole with a sliding fit around the shaft. Such a sliding fit means that the space between the brake body and the shaft is mm or less. In this preferred embodiment the elastic region in the brake body provides a pivot point or hinge for the brake shoe. Due to the fully open slit the brake shoe can rotate around the pivot point and thus be pushed against the shaft by the spring. Due to the sliding fit only a small stroke is necessary for the piezo actuator. The brake body is fixed to a stationary non-rotating element, for instance to the housing of a joint of a robot arm. The brake body is very compact, since the brake shoe is an integral part of the brake body. Preferably the brake body has a ring shape that fits around the shaft. Such a shape is easy to manufacture and it is at the same time light and compact. The brake body is fixed, for instance by bolts, to the stationary non-rotating element. The brake shoe is free, i.e. it is not fixed to the element, but only attached to the elastic region, so that it can move around the pivot point when actuated or released by the spring and the piezo actuator.

A piezo actuator is less suited for larger strokes, therefore preferably the distance between the brake shoe and the shaft when the switch-off device is active is between 40 and 60 micrometer. Such a distance provides enough clearance for the shaft to rotate even if the shaft and shoe may rub slightly. The 40 to 60 micrometer distance is achievable with a relatively small and inexpensive piezo actuator that needs very little power.

The safety brake system is meant as a power-off, emergency or parking brake. Preferably the brake body is produced of a material with self-lubricating properties. Such a material still has enough friction to be useful as brake material, but it will prevent fretting corrosion. Fretting corrosion may seize the shaft and the brake shoe together, so that unlocking becomes impossible. The self-lubricating material prevents this. The preferred material with self-lubricating properties is a sintered bronze or brass and the shaft is produced of stainless steel. These material combinations for the brake body and the shaft have excellent running properties, provide enough friction force for the brake and do not seize or corrode the brake system, so that long term reliable operation of the brake system is possible. In order to make a brake body and shaft with narrow tolerances for the sliding fit it is advantageous if the brake body and the shaft are run-in. This means that before actually using the brake system the shaft is rotated about 100 times within the brake body, so that any surface imperfections are equalized. After such a run-in the shaft and brake body are disassembled, cleaned to remove any debris and reassembled for actual use.

The size of the brake shoe can be varied depending on the braking power needed. This means the distance between the fully open slit and the partially open slit can be varied. Preferably the brake shoe covers between 20 and 30% of the circumference of the brake body. In that case the brake body provides a stable anchor point for the brake shoe and the brake shoe is sufficiently large to provide enough braking power.

In a preferred embodiment the partially open split has a rounded tip. The rounded tip prevents fatigue cracks that could originate at a very sharp tip when the brake system is used very often. Here a rounded tip means that the tip has a radius of 1 mm or more.

The spring and the piezo actuator preferably can act on the brake shoe near the fully open split. Here the forces generated by the spring have a maximum effect on the braking power.

### DESCRIPTION FIGURES

The invention is further explained with the help of the following drawing in which

FIG. 1 shows a schematic view of the safety brake system according to the invention,

FIG. 2 shows a cross-sectional view of the safety brake system,

FIG. 3 shows a 3-dimensional section view of the safety brake system from the spring side,

FIG. 4 shows a 3-dimensional section view of the safety brake system from the piezo side.

The invention regards a safety brake system for a rotating shaft. Conventional brake systems have a brake disc (often also called rotor or rotatable disc) and use a brake pad with friction material and a backing plate. Such a brake-system needs a lot of space. Known safety brake systems have relatively large dimensions. In particular in the applications foreseen, inter alia rotary joints of robotic systems, a compact design is often required both for performance as well as cost-effectiveness.

In such an application, the safety brake is, in normal working conditions, only used as a ‘parking’ brake e.g., acting on a non-rotating axis. However, when there is an emergency situation, which specifically also includes a power drop to the braking system, the brake should act automatically. In many applications safety brakes are required for rotating shafts. These types of brakes are especially useful in the joints of robot arms. Such arms often contain many joints that need to be locked in case of an emergency or when one degree of freedom of the robot arm is not used.

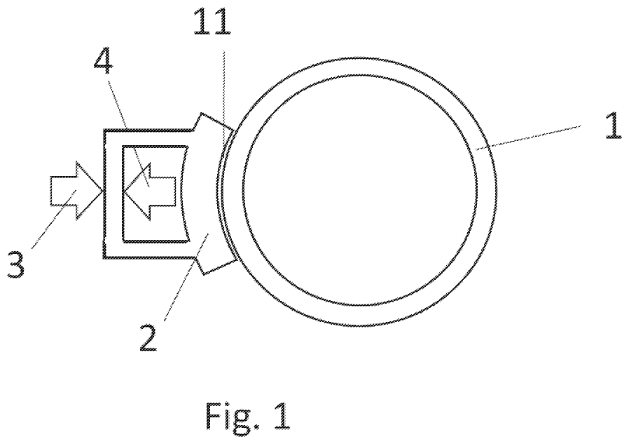

FIG. 1 shows a safety brake system comprising a round rotatable shaft 1 locked with a constant-on braking device 2 activated by a spring 3 and a switch-off device 4 for the braking device 2 that counteracts the spring 3, so that the shaft 1 is unlocked and can rotate when the switch-off device 4 is active. The constant-on brake device 2 comprises a brake shoe 2 pushed against the shaft 1 by the spring and the switch-off device 4 is a piezo actuator 4 that counteracts the spring 3. The spring 3 and the piezo actuator 4 act between on the one side the brake shoe 2 and on the other side on the stationary non-rotating element, which can be for instance the housing of the brake system. In this example the shaft 1 is a hollow tube. This is done to make the shaft 1 lighter. Of course for the shaft 1 also a solid cylinder can be used. The brake system is normally constant on since the spring 3 pushes the brake shoe 2 against the shaft 1. When the shaft 1 needs to rotate the piezo actuator 4 counteracts the spring, thus releasing the brake shoe 2 from the shaft 1. In case of an emergency or when the shaft 1 needs to be locked (parked), the power to the piezo activator 4 is shut off and the spring 3 pushes the brake shoe 2 against the shaft 1 to stop any rotation. The inventive brake system is significantly more compact compared to known solutions, as no complex ball carrier rotor or brake disc is required. As a consequence, performance of the overall system can improve and design constraints relaxed. A piezo actuator is very quick. It switches in much less than 1 ms. Thus the switch-off device works also very fast. Moreover the piezo actuator 4 consumes little energy and thus has a low heat dissipation. In case of a power failure the piezo actuator 4 will receive no power, so that it cannot counteract the spring 3 anymore. The spring 3 will then push the brake shoe against the shaft. Thus providing a fail safe locking mechanism for the shaft 1, i.e. the shaft 1 will be locked in case of a power failure. The brake shoe 2 fits to the outer radius of the shaft 1. The dimensions of the brake shoe 2, i.e. the axial (width) and the tangential (length along the radius of the shaft 1) dimensions depend on the required braking force. The safety device according to the invention resembles a hybrid between an inverse drum brake and a belt brake. In a drum brake a brake pad is acting on the inner side of a drum. Here a brake shoe is acting on the outside of a shaft like in a belt brake. Moreover in a drum and belt brake the brakes are activated, i.e. not of the constant-on type.

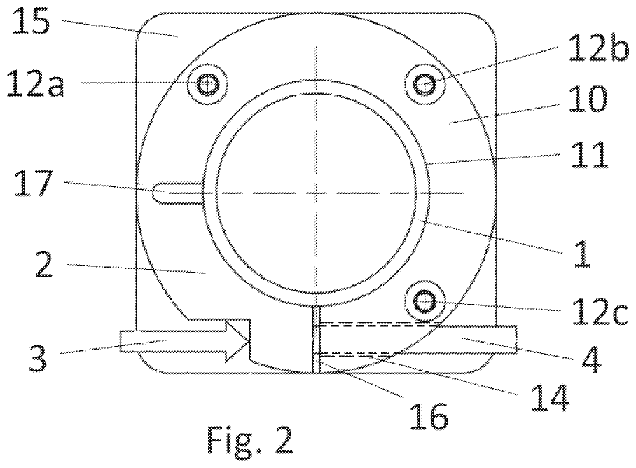

FIG. 2 shows a preferred embodiment. Preferably the shaft 1 is surrounded by a brake body 10 comprising a cylindrical hole 11 with a sliding fit to the shaft 1. The shaft 1 has a diameter of 40 mm. The brake body 10 is fixed with bolts in holes 12a, 12b and 12c to a stationary non-rotating element 15, here the housing of the joint of a robot arm. In this case the brake body 10 has the shape of a ring to make a very compact and light brake body 10. The radial width of the ring is 10 mm and the thickness of the ring is 5 mm. The brake body 10 is provided with a fully open radial slit 16 that splits the brake body 10. This fully open slit 16 has a width of 1 mm. There is also a partially open radial slit 17 that provides an elastic region in the brake body 10. The partially open slit has a width of 3 mm and a length of 7 mm, leaving 3 mm of the brake body 10 intact. The radius at the tip of the radial slit 17 is 1.5 mm. The brake shoe 2 comprises the part of the brake body 10 between the fully open radial slit 16 and the partially open radial slit 17. The brake shoe 2 can pivot around the elastic region and is loaded by the spring 3 against the shaft 1. The piezo actuator 4 can act directly on the brake shoe 2 via hole 14 in the brake body 10 and thus can counteract the spring 3. The backsides of the spring 3 and the piezo actuator 4, i.e. the parts not interacting with the brake shoe 2, are fixed to the stationary non-rotating element 15. The brake body 10 comprises a circular hole 11 with a sliding fit around the shaft 1. Such a sliding fit means that the space between the brake body 10 and the shaft 1 is 0.1 mm or less. In this preferred embodiment the partially open slit 17 in the brake body 10 provides an elastic pivot point or hinge for the brake shoe 2. Due to the fully open slit 17 the brake shoe 2 can move around the pivot point 17 and thus be pushed against the shaft 1 by the spring 3. Due to the sliding fit only a small stroke is necessary for the piezo actuator 4. The brake body 10 is very compact, since the brake shoe 2 is an integral part of the brake body 10. The brake body 10 is bolted by bolts in holes 12a,b,c to the stationary element 15. The brake shoe 2 is free, i.e. it is not fixed to the element 15, but it can rotate around the pivot point 17 when actuated or released by the spring 3 or the piezo actuator 4.

For a shaft 1 with a 40 mm diameter, a stroke of the piezo actuator 4 of approximately 0.1 mm is required to make the shaft 1 completely free to rotate. This requires a piezo actuator with a rather large stroke. Preferably the distance between the brake shoe 2 and the shaft 1 when the switch-off device 4 is active is between and 60 micrometer, preferably 50 micrometer. Such a distance provides enough clearance for the shaft 1 to rotate even if this leads to a slight rubbing when the piezo actuator 4 is active. The 50 micrometer distance is achievable with a relatively small and inexpensive piezo actuator 4 that needs very little power.

The safety brake system is meant as a power-off, emergency or parking brake. Preferably the brake body 10 is made of a material with self-lubricating properties. Such a material still has enough friction to be useful as brake material, but it will prevent fretting corrosion. Fretting corrosion may seize the shaft 1 and the brake shoe 2 together, so that unlocking becomes impossible. The material with self-lubricating properties prevents this. The preferred material is a sintered bronze or brass and the shaft is produced of stainless steel. These material combinations for the brake body 10 and the shaft 1 have excellent running properties, provide enough friction force for the brake and do not seize or corrode the brake system, so that long term reliable operation of the brake system is possible. In order to make a brake body and shaft 1 with narrow tolerances for the sliding fit it is advantageous if the brake body 10 and the shaft 1 are run-in. This means that before actually using the brake system the shaft 1 is rotated about 100 times within the brake body 10, so that any surface imperfections are straightened. After such a run-in the shaft 1 and brake body are disassembled, cleaned to remove any debris and reassembled for actual use. A clean environment (no grease) is preferred to promote constant brake performance.

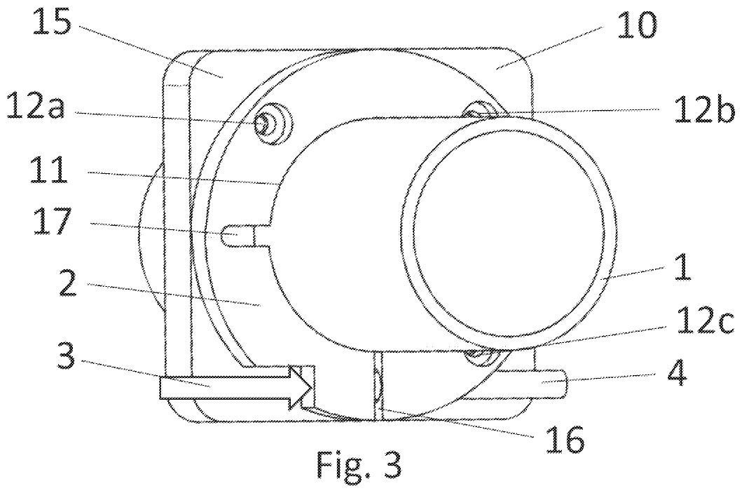

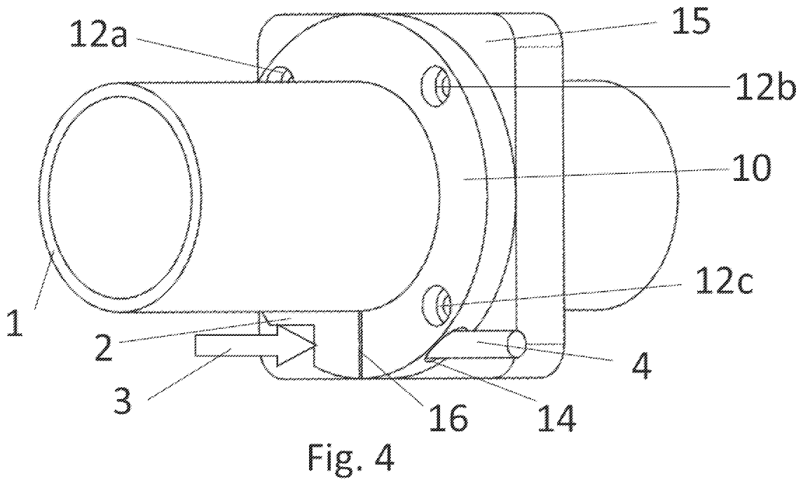

The size of the brake shoe 2 can be varied depending on the braking power needed. This means the distance between the fully open slit 16 and the partially open slit 17 or the width of the brake shoe 2 can be varied. FIGS. 2 to 4 show how the brake shoe 2 covers between 20 and 30% of the circumference of the brake body in this case a quarter, i.e 25%. This means that the brake body 10 provides a stable anchor point for the brake shoe 2 and the brake shoe 2 is sufficiently large to provide enough braking power.

Preferably the partially open split 17 has a rounded tip. Since this split serves as an elastic hinge, the stresses at the tip of the split should remain elastic to avoid cracks building that could lead to failure of the brake shoe 2. The rounded tip prevents fatigue cracks that could originate at a very sharp tip when the brake system is used very often. Here a rounded tip means that the tip has a radius of 1 mm or more.

The spring 3 and the piezo actuator 4 preferably act on the brake shoe near the fully open split 16. This means that as shown in FIGS. 2-4 the spring 3 and the piezo actuator 4 can be placed opposite each-other just outside the shaft 1. At this place the forces generated by the spring have a maximum effect on the braking power.

Variations of the inventive brake system are possible. More than one partially open split 17 can be used in the brake shoe 2 to elastically deform the brake shoe, so that it better fits to the shaft 1. These splits can have different depths, so that the hinges created have different stiffness in the hinge. The partially open split 17 can also be made from the outside of the brake body 10, so that the surface that contacts the shaft 1 is a continuous surface. The partially open split 17 can be modified to a larger width, so that the material left in the split acts more like a leaf spring that accommodates not just a pivoting motion but also a slight radial motion to obtain a better fit of the brake shoe 2 to the shaft 1. The spring in the embodiment pushes the brake shoe 2 on the shaft. It is also possible to locate the spring and the piezo actuator parallel next to each-other. In that case the spring pulls the brake shoe 2 towards the shaft 1. Placing the spring 3 and piezo actuator 4 closer to the pivot point is possible but this means a shorter stroke but a larger force. The shaft 1 can be used as manufactured but can also be provided with a special coating, either to increase friction to provide a stronger brake or to reduce or prevent any wear.

1. A safety brake system comprising a round rotatable shaft locked with a constant-on braking device activated by a spring and a switch-off device for the braking device that can counteract the spring, so that the shaft can be unlocked and can rotate when the switch-off device is active, characterized in that the constant-on braking device comprises a brake shoe that can be pushed against the shaft by the spring and the switch-off device is a piezo actuator that can counteract the spring.

2. The safety brake system according to claim 1, characterized in that the shaft is surrounded by a brake body comprising a cylindrical hole with a sliding fit to the shaft, the brake body is fixed to a stationary non-rotating element, where the brake body is provided with a fully open radial slit that splits the brake body and a partially open radial slit that provides an elastic region in the brake body, where the brake shoe comprises the part of the brake body between the fully open radial slit and the partially open radial slit and where the brake shoe can pivot around the elastic region and can be loaded by the spring against the shaft.

3. The safety brake system according to claim 2, characterized in that the brake body has a ring shape.

4. The safety brake system according to claim 1, characterized in that a distance between the brake shoe and the shaft when the switch-off device is active is between 40 and 60 micrometer.

5. The safety brake system according to claim 2, characterized in that the brake body is produced of a material with self-lubricating properties.

6. The safety brake system according to claim 5, characterized in that the material with self-lubricating properties is a sintered bronze or brass and the shaft is produced of stainless steel.

7. The safety brake system according to claim 5, characterized in that the brake body and the shaft are run-in.

8. The safety brake system according to claim 2, characterized in that the brake shoe covers between 20 and 30% of a circumference of the brake body.

9. The safety brake system according to claim 2, characterized in that the partially open split has a rounded tip.

10. The safety brake system according to claim 1, characterized in that the spring and the piezo actuator can act on the brake shoe near the fully open split.
